(19) United States
(12) Patent Application Publication
(10) Pub. No.: US 2002/0032769 A1
(43) Pub. Date: Mar. 14, 2002

(54) Network management method and system

(76) Inventors: Sharon Barkai, Shoham (IL); Ariel Noy, Herzliya (IL); Yoel Shkolnisky, Or-Yehuda (IL)

Correspondence Address: Guy Perry, Skadden, Arps, Slate, Meagher & Flom LLP, Four Times Square, New York, NY, 10036, US

(21) Appl. No.: 09/844,303

(22) Filed: Apr. 27, 2001

Related U.S. Application Data
(63) Continuation of application No. 09/698,272, filed on Oct. 30, 2000.
(60) Provisional application No. 60/200,507, filed on Apr. 28, 2000.
(60) Provisional application No. 60/222,660, filed on Aug. 3, 2000.
(60) Provisional application No. 60/222,662, filed on Aug. 3, 2000.
(60) Provisional application No. 60/222,729, filed on Aug. 3, 2000.

(51) Int. Cl. G06F 15/173; G06F 17/60

(52) U.S. Cl. 709/224; 705/28

(57) ABSTRACT

A network management system provides distributed task and data processing services to management processes by employing distributed autonomous agents. The network management system includes management units that are associated with network elements of the network. The management units store a dynamically updated model of the corresponding network elements. The model is used to implement data gathering tasks as well as network control operations. The model includes autonomous agents, each modeling a network element. The agents communicate with one another and cooperate to facilitate the implementation of a distributed algorithm. The management system provides the management processes with data management as well as one step network control operation services. Accordingly, the management processes do not process a large amount of data or execute step-by-step network control operations.

### PRIORITY CLAIM

This application claims priority to U.S. provisional patent application No. 60/200,507, to U.S. provisional patent application No. 60/222,660, to U.S. provisional patent application No. 60/222,662, and to U.S. provisional patent application No. 60/222,729. This application is a continuation application of U.S. patent application Ser. No. 09/698,272.

### FIELD OF THE INVENTION

The present invention relates to communication networks. Particularly, the invention relates to management of communication networks.

### BACKGROUND

Communication networks are used to facilitate data connections between electronic devices situated in remote locations. Communication networks are used to transmit both analog and digital data, such as voice and computer data. The network generally consists of a collection of interconnected nodes. Network nodes include routers, bridges, and switches, as well as various specialized or general purpose components. The network is usually employed by several devices at the same time to facilitate numerous connections and communication sessions. The network nodes can usually be controlled to vary the way that connections are facilitated or to report information relating to connections facilitated by the nodes. The information is used for applications such as billing, quality of service, activity tracking, balancing, optimization, and fault detection. Accordingly, a management system is employed to gather such information and control the operation of the network.

The management system is provided with information from the nodes of the system, processes the information, and responds accordingly. Control commands to the network are handled in a similar manner whereby commands are transmitted to targeted nodes so as to change the behavior of the network.

The centralized management systems, which are usually employed to control network operation by employing modules that address specific functions, require vast processing power. Substantially all information that is generated by the network is provided to a central processing element. Therefore, the central processing element must analyze a sizeable amount of data. This processing power requirement often inhibits the scalability of networks, as network complexity is limited by the processing power of the central element. Furthermore, the centralized systems often duplicate efforts by analyzing the same data several times when performing different tasks. Therefore, there is a need for a more efficient and scalable method and system for facilitating the management of communication networks.

### SUMMARY OF THE INVENTION

In accordance with the invention, a system is provided that employs independent software agents to facilitate management and control of a network. Each independent agent models a particular network node, or network element. Each agent models the functional behavior of the network element so as to provide a management utility with a model of the network that includes up-to-date indication of network conditions. The agent modeling is of both physical and logical functionality in the network element. Finally, network characteristics are modified when the agent communicates with an associated network element in response to commands from a management utility.

In the central management approach employed by prior management systems, substantially all decisions are made by the external management module. All data relating to the network operation is provided to the management module for analysis. The analysis is performed and a decision is made. At times, the decision is not to take action since an alternate link or path is already available. Other times, after the data is processed, a command is sent to a specific network element to modify its operation on a physical or logical level. Nonetheless, all network element data is provided to the central module for analysis, regardless of whether action is to be taken or which part of the network is affected.

The system of the present invention increases the efficiency of higher level management processes by reducing the amount of data that is provided to the processes. In one embodiment, the system performs some of the decisions that would be made by the management program in a distributed manner to reduce the processing needs of the management process. The system of the invention also facilitates the efficient implementation of network level commands in the top-to-bottom flow.

In one embodiment, the invention provides for a management unit that includes a warehouse module, which is operatively coupled to at least one network element, and is adapted to interact with the network element to facilitate data retrieval and network element operation control. The management unit includes an agents module, which is modeling functional operation of at least one network element that is in communication with the management unit, and is operatively coupled to the warehouse module to facilitate communication with the associated network element. The agents module is also adapted to transmit commands to the warehouse module to facilitate service requests. Finally, the management unit includes a presentation module, which is facilitating local implementation of task requests from external management applications. The presentation module is communicating with the agents module to transmit service requests to the agents module in accordance with the task requests.

In another embodiment, the invention provides a method for processing network event data in a network that includes network elements coupled together by communication links. The network elements of the network have logical and physical functions. The method includes modeling the internal state behavior of the logical and physical functions of network elements by associating a modeling component with each function of a network element. The method also includes identifying dependencies and peer links for said logical and physical functions of the network elements. The method associates each modeling component with corresponding acquaintance links in accordance with the identified dependencies and peer links for the associated function of the modeling component. Finally, the method transmits at least one message from a first modeling component to a second modeling component in accordance with the acquaintance links of the first modeling component in response to network event data to facilitate the distributed processing of the network event data.

In yet another embodiment, the invention provides a method for implementing a network operation modification in a communication network that includes network elements coupled together by communication links. The method associates each network element with at least one component that models the operation of functions in the network element. This component is adapted to transmit operating commands to the network element. The method receives a command indicating a requested change in operation of the communication network. The method verifies proper communication network operation by facilitating the command in the network modeling components. Finally, the method implements the command by employing the network modeling components corresponding to each network element associated with the command if proper operation is verified.

In an alternate embodiment, the invention provides a method for executing a network task in a communication network that includes a plurality of network elements operatively coupled by communication links and a management unit associated with each network element. The method receives task request data into a first management unit. The method determines whether a portion of the task is applicable to the first management unit. The method also prompts the execution of a portion of the requested task in the first management unit when a portion of the task is applicable to the first management unit. The method then determines whether all portions of the task have been prompted for. Finally, the method transmits a message to at least a second management unit when all portions of the task have not been prompted for. The message includes the task request data.

In another embodiment, the invention provides a method for modeling the functionality of a network element in a network. The method communicates with the network element to identify functionality in the network element. The method spawns a modeling element corresponding to at least one identified functionality in the network element. The method then communicates with the network element to identify attribute data for the identified functionality. Finally, the method updates the modeling data employed by the modeling element in accordance with the attribute data for the identified functionality.

The invention also provides a method for identifying target management components for network task operations. The method associates an autonomous agent with at least one network element in the network. The method also associates a plurality of device components with each autonomous agent where each device component models a data network entity. The method stores dependency links between device components of an autonomous agent in accordance with dependencies associated with the modeled data network entity corresponding to the autonomous agent. The method then stores peer links between device components of a first autonomous agents and a second autonomous agent in accordance with logical and physical links between a data network entity corresponding to the first autonomous agent and a data network entity corresponding to the second autonomous agent. Finally, the method refers to the stored dependency links and peer links to identify target device components for network management task implementation.

In another embodiment, the invention provides a method for passing information between autonomous agents modeling logical and physical functions. The method stores relationship identifiers for each modeling agent. These relationship identifiers correspond to physical and logical connections between the functionalities. The method then transmits a message from an autonomous agent in response to an event by employing at least the stored relationship identifiers associated with the agent.

In yet another embodiment, the invention provides an extensible software architecture for facilitating the mapping and analysis of a communication network. The software is on a computer readable medium and includes a mapping component which has executable code for scanning a network and for generating a map of the network. The map is represented by the mapping component as a data structure which comprises a collection of device components and links. The device components represent functions of network elements of the network while the links represent relationships between the device components. The software also includes an application program interface, which includes methods that enable external applications to access the device components of the map data structure to obtain information about the network, and which includes methods that enable the external applications to modify the operation of the network and to convey network information to a user via a user interface.

### BRIEF DESCRIPTION OF THE DRAWINGS

FIG. 1 illustrates a recognized process flow arrangement for performing network management tasks;

FIG. 2 illustrates an arrangement of network elements and management modules in accordance with the invention;

FIG. 3 illustrates the structure of a management unit of FIG. 2;

FIG. 4 illustrates the structure of an agent module of the management unit of FIG. 3;

FIG. 5 illustrates the structure of a warehouse module of the management unit of FIG. 3;

FIG. 6 illustrates an exemplary arrangement of device components in an agent module;

FIG. 7 illustrates an exemplary relationship between device components of several agent modules;

FIG. 8 is a flow diagram illustrating the operation of the investigation component of FIG. 4;

FIG. 9 is a flow diagram illustrating the operation of the device agents when collecting data;

FIG. 10 illustrates management system components associated with the provision of services to external applications;

FIG. 11 illustrates management system components and external application components associated with facilitating an information request task; and

FIG. 12 is a flow diagram illustrating the operation of the components of FIG. 11 when facilitating the information request operation.

### DETAILED DESCRIPTION

The structure and operation of a network management system in accordance with the invention will now be discussed with reference to structural and flow illustrations of an exemplary management system. First, the process flows for network management processes will be discussed with referenced to a process flow mapping so as to illustrate the role that a system of the invention has within the broad scheme of network management processes. Next, the structure of an exemplary system will be discussed with reference to logical structure diagrams. Also, the operation of modules of the exemplary system will be discussed with reference to flow diagrams. Finally, example management modeling will be discussed to illustrate the operation of the management network with an exemplary network element arrangement.

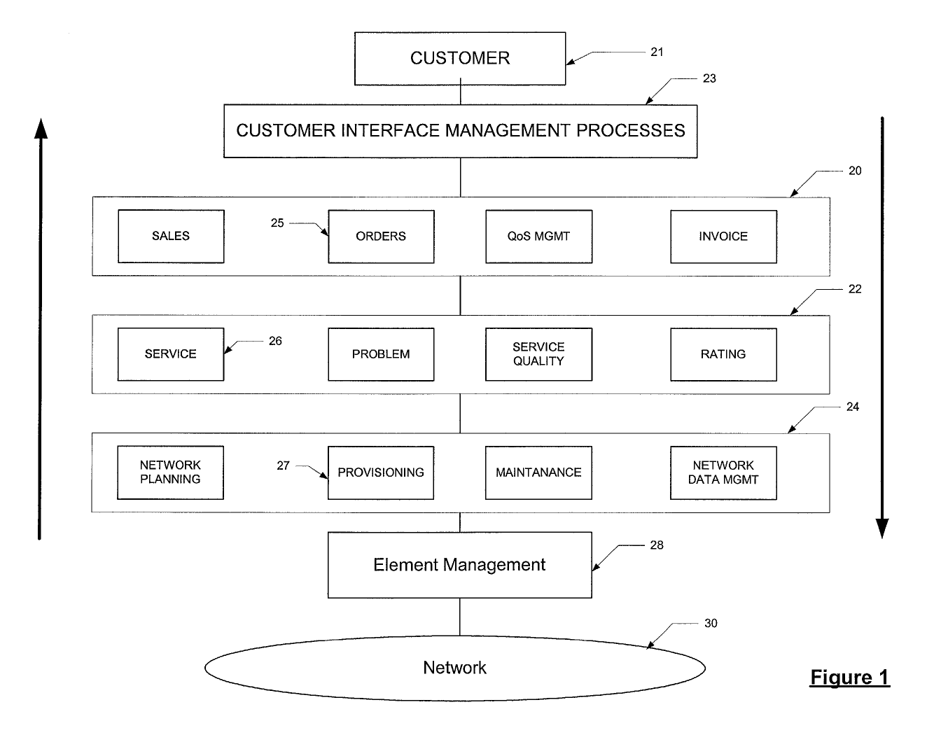

FIG. 1 illustrates a management hierarchy that is commonly referenced in structuring process flows for network management tasks. The illustrated arrangement of processes of FIG. 1 is known as the Telecommunication Operations Map (TOM). The TOM provides that network management tasks should flow from a high level business application layer 20 through a workflow application layer 22 and on to a data management application layer 24. Reporting, which is the reverse process, should flow from the data management application layer 24 through the workflow application layer 22 and on to the business application layer 24. Additionally, a customer interface management process layer 23 is provided between customers 21 and the business application layer 20. Further, below the data management application layer 24 are element management processes 28, which facilitate interaction with the network 30.

The business layer applications are preferably those used to initiate business processes from customer interaction. Such business processes include billing, sales, discount handling, promotions, problem handling, quality of service, and performance measuring. The workflow applications are preferably those used to organize the execution of tasks to implement desired business tasks. The workflow applications include maintenance, service planning, configuration, quality, and discount. The data management applications are preferably used to communicate with the element management to facilitate commands received from the workflow applications or to report network event data to the workflow applications. Data management applications include network planning, provisioning, inventory, maintenance, and data management. Accordingly, the data management applications serve as the interface between the network management applications and the managed network elements.

An example flow is when a customer wants to change a long-distance carrier. The interaction is initiated by an order process 25 in the business layer, which preferably receives the customer request from customer interface process. The order process 25 interacts with a service process 26 in the workflow layer. The service process preferably receives such requests and facilitates their implementation in accordance with a service protocol. The service process 26 interacts with a provisioning process 27 in the data management layer to transmit a command to a particular switch that is associated with the telephone line of the customer, instructing the switch to route long distance calls to the network node corresponding to the selected long distance carrier. The provisioning process 27 identifies the relevant switch and transmits a command to an element management process to implement the change in routing. Accordingly, the processes flow from top to bottom by a business process event triggering requests to work flow processes and down to data processes.

When the network is not operating properly, the data processes need to properly deliver commands to network elements. Solutions to some network problems include moving customer links between lines, routing data over an alternate path, or instructing a router to share a link between two client transmissions. Accordingly, the management applications usually take some action in response to changes in the operation of network elements.

A management system in accordance with the invention is applicable to the element management layer 28 of the TOM in FIG. 1. A system of the invention provides network data to the management processes as well as implementing network configuration and modification tasks.

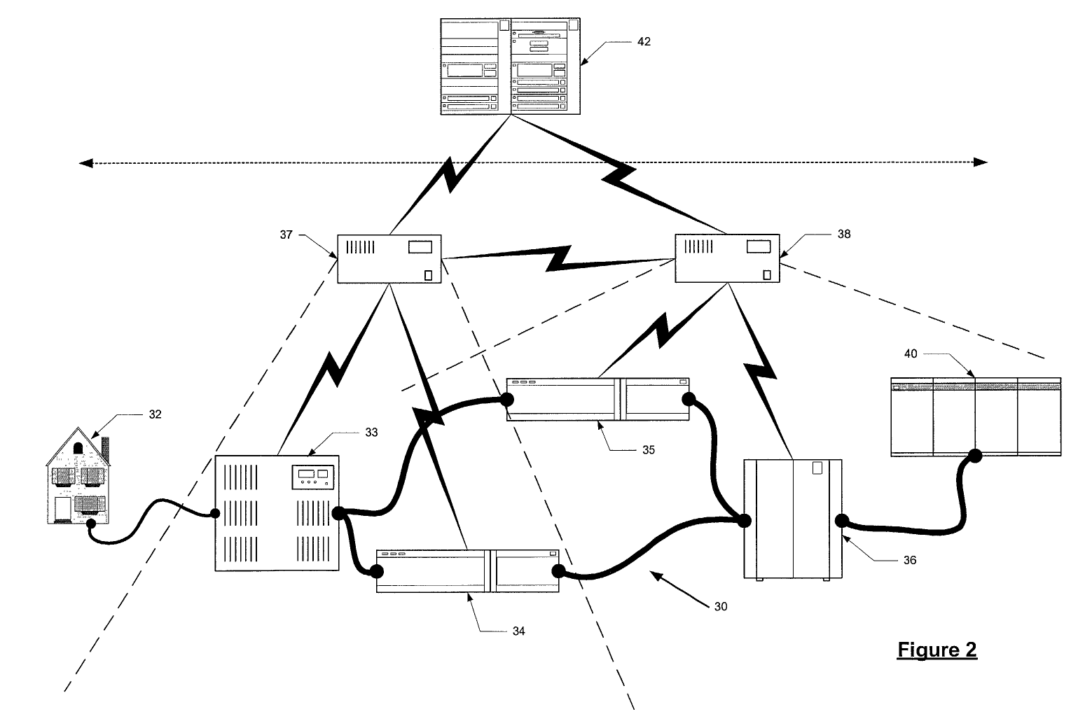

FIG. 2 illustrates an exemplary network arrangement 30 and a corresponding management network in accordance with the invention. A communication network generally includes various kinds of nodes, which facilitate the transfer of data between elements in the network. For example, as illustrated in FIG. 2, data communication between a home user's computer 32 and an internet service provider (ISP) router 40 is facilitated by a Digital Subscriber Line Access Multiplexer (DSLAM) server 33, a first ATM switching element (herein “ATM switch”) 35, a second ATM switch 34, and a service selection switch 36. The DSLAM server 33 facilitates a data connection between the home computer 32 and the network. The ATM switches, 34, 35 facilitate the transfer of data over various logical protocol in accordance with the network protocol layer configuration. The network elements 33, 34, 35, 36, preferably cooperate to provide a data communication path from the home computer 32 to the ISP 40.

The network elements are generally referred to as inbound network components while the management network elements are referred to as outbound network components. Each network element is preferably associated with a management unit of the outbound network. A management unit is advantageously located in close physical proximity to the associated network elements so as to provide convenient and cost effective communication between the network elements and the management unit. In the illustration of FIG. 2, two management units 37, 38, are associated with the network elements 33, 34, 35, 36, 40. A first management unit 38 is associated with the second ATM switch 35, the service selection switch 36, and the ISP 40. A second management unit 37 is associated with the DSLAM server 33 and the first ATM switch 34. Each management unit 37, 38, is preferably operatively in communication with the corresponding network elements by way of a management link to each network element. In one embodiment, the management units 38, 37 communicate with network elements using an SNMP protocol. The SNMP protocol is preferably used for management tasks such as provisioning and performance data collection. The SNMP protocol is preferably used to collect information in both polling mode and traps mode. The polling rate is preferably configured and controlled by the external management applications in the external server 42.

In another embodiment, the management units 38, 37 communicate with network elements by a Telnet protocol. The Telnet protocol is preferably used for management tasks and performance data collection. In this embodiment, the Telnet collection method is based on text parsing of session output. In some embodiments, the management units 38, 37 support multiple proprietary protocols using generic methods for text parsing.

The management units 38, 37 are preferably operatively in communication with one another by way of the outbound network. In one embodiment, the management units 38, 37 are also operatively in communication with external systems 42 by way of the outbound network. In one embodiment, the external system 42, such as an OSS\BSS system, communicates with the management units 38, 37 over WAN, either by directly connecting to a serving management unit or by using the messaging component of a unit (discussed below) to interact with the entire management system. The connection between the management units 37, 38 and external systems 42 is preferably facilitated by using defined interfaces such as CLI, XML, or CORBA, which enable access to functionality and information within the deployed management units.

Data paths between nodes of a network are commonly facilitated by several potential routes. In the illustrated network, a data path between the home computer 32 and the ISP 40 is available either by the path from the DSLAM 33 through the first ATM switch 34 and through the service selection switch 36 or by the path from the DSLAM 33 through the second ATM switch 35 and through the service selection switch 36. When data are transmitted from the home computer 32 to the ISP 40, the user is not aware of the network path used to facilitate the transmission. Furthermore, the network elements are usually not aware of the path used to facilitate the transmission. Accordingly, merely executing the simple task of determining the path through which data travel in a network is sometimes very complicated because of network size and network element complexity. To make things worse, often times data are transmitted within each network element over several possible physical and logical connection, since the network elements switch connection lines and internal paths in response to local events, such as down circuits or data overflow.

In accordance with the invention, the network element functioning is viewed as involving various layers and protocols. Network elements are seen as including a physical layer of functions carrying electrical or optical signals to a wire or a transmitter. Furthermore, network elements are seen as including a logical layer of, such as those functions, employing the physical functions to transmit data. Several intermediate logical functions are usually interposed between the physical function and a high level logical function, such as an IP protocol. The observed logical layer functions include IP connections, ATM ports, Bridging, Routing, Switching, and Ethernet. Accordingly, network elements are seen as transmitting data by employing various functions, both physical and logical. Depending on the purpose for observing the network, all or some of those functions are of interest.

In the system of the present invention, the physical and logical operation of the network is modeled and is controlled by autonomous components within the management units. The data collection and reporting to the management processes is selectively made, in accordance with logic that is built into the autonomous components. Accordingly, the external management processes receive already synthesized data relating to network conditions without the need to perform substantial data processing tasks prior to employing the data.

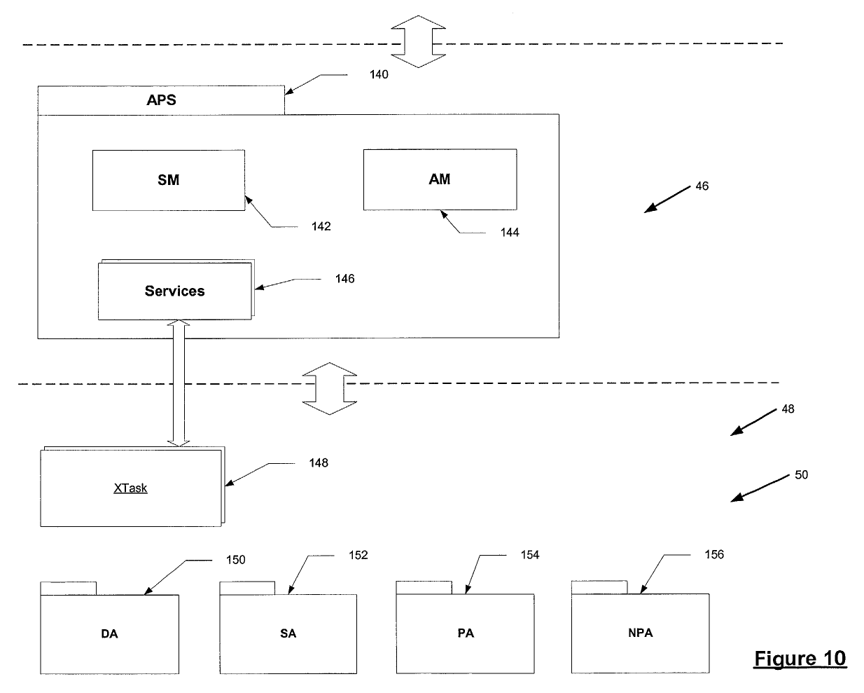

The management units also provide for efficient execution of provisioning tasks, which modify the operation of network elements. As discussed below, the management units cooperate to implement provisioning request without the need for the external management process to locate the applicable network elements or to format instructions for each target network element. The facilitation of provisioning tasks by the management units is discussed with reference to FIGS. 10, 11, and 12.

The system of the present invention provides for the efficient management of a network by including parts of an algorithm in each of the autonomous components. Accordingly, each modeling component makes some decisions which, in the aggregate, result in the efficient synthesizing of data and execution of tasks. The management units are easily integrated into the network and interoperate seamlessly. External systems that are served by the management units do not need to connect to all the units. A connection to any of the units presents to the external application all the functionality and knowledge of the management units.

In one embodiment, each network element in the managed network is associated with an agent module that models the functionality of the network element. The agent module is a software component that is preferably running in the corresponding management unit. In other embodiments, the agent module is running as part of a network element, when observing functionality in that particular network element or functionality in another network element.

The element management layer of the invention includes multiple management units, enabling concurrent processing in distributed units. The configuration of management units is made invisible to the agent modules by the use of underlying functionality that includes messaging services such as, for example, Java Messaging Services (JMS). Accordingly, the location of an agent module does not inhibit the operation of the agent module, whereby an agent module can be delegated between management units for improved performance, e.g., load balancing.

The modeling of functionality by the agent modules entails that an agent module react to network events and interact with other agent modules, as the modeled network element would react and interact with other network elements. The term “models,” as used in this discussion, includes storing information about the operation of a logical or physical aspect of a device. In some context, the “modeling” refers to determining how the modeled entity would react in light of a given input condition and a state of operation. For example, such reaction can include changing operating status, transmitting data, reporting events, or not taking any action. “Modeling” further includes recognizing other elements of the network that are affected by the operation of the modeled entity. For example, such elements include higher level functions that employ the modeled entity or same level functions that work together with the modeled entity to provide services.

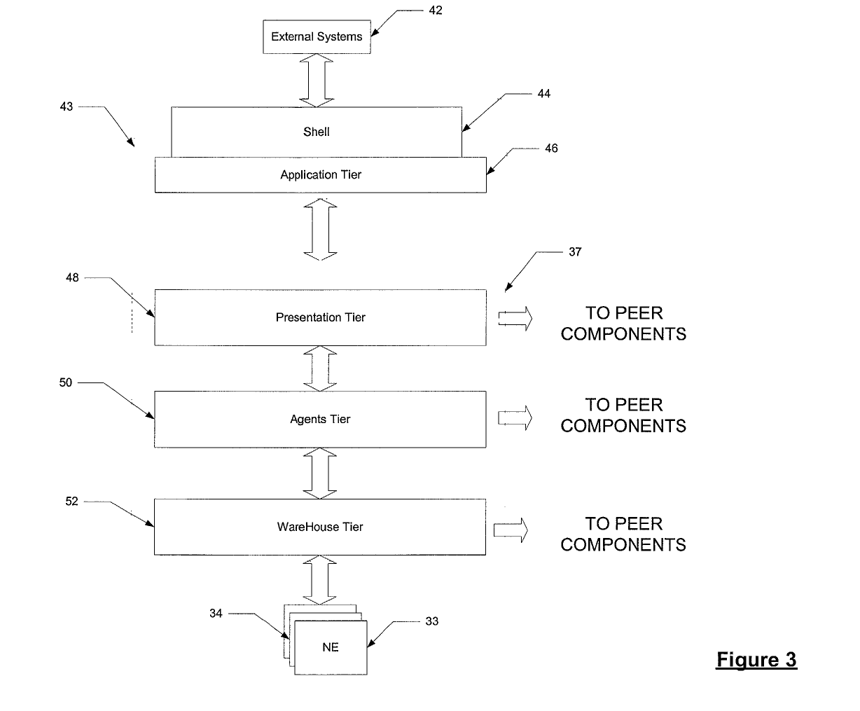

FIG. 3 illustrates the structure of a management unit 37 and external interfaces 43 in accordance with the invention. In one embodiment, each management unit 37 includes three primary tiers: a warehouse tier 52, an agents tier 50, and a presentation tier 48. An external interface module 43 includes an application tier 46 and a shell interface 44. In the illustrated embodiment, the shell interface 44 is provided to facilitate the communication between the management unit 37 and external management systems 42.

The primary tier components are preferably part of one functional implementation residing in a management unit or in a network element. The warehouse tier 52 facilitates the communication between the agent modules in the agents tier 50 and the network elements. The warehouse tier 52 further facilitates the storage of network configuration data and of management network component data.

The agents tier 50 includes the agent modules that model the behavior of network elements. The presentation tier 48 facilitates the interface between the agents in the agents tier 50 and the application interfaces in the application tier 46. The presentation tier 48 further communicates with the warehouse tier 52 for information retrieval and task activation. The presentation tier 48 provides registration methods to the different elements of the management unit through its Object Request Broker (ORB) component. The presentation tier 48 further provides a registration method for remote clients, such as external systems, which facilitates information retrieval from the management units. Accordingly, information updates are reported to the registered clients as updates are received by the presentation tier 48. For example, a remote client registers to receive information relating to fault events in a network element that is managed by the management unit. When a fault event is reported by the associated network element, a message is transmitted to the registered client to indicate that a fault event was detected.

The application tier 46 provides application program interface modules, which allow external applications to invoke agent operations. The application tier 46 performs registration and method invocation on behalf of its clients. The application tier clients are preferably applications that are running on external systems (e.g., OSS/BBS systems) that are coupled to the management unit. Clients register with the application tier 46 for information on network entities in order to provide surveillance, provisioning, and auto-discovery functionality (discussed below). The application tier 46 preferably resides within a unit, which serves as a generic interface to the management unit and is used by external systems, such as OSS and BSS systems. The application tier 46 includes processes that perform tasks such as data abstraction, network modeling, protocol translation, and API commands adaptation. In another embodiment, the application tier 46 is external to the management unit main functionality and is deployed within the management unit server or outside the server on a remote system, such as on an external PC client. The network model (elements and connections) is preferably maintained by application tier components and is used for modeling entity relations and for processing information received from the presentation tier 48. Received information is advantageously correlated to the network model by the application tier 46 and is made available to management units or external systems by way of the tier interfaces. The tier interfaces are preferably a set of plug-in components that facilitate communication with external systems by employing various protocols such as XML, CORBA, and CLI.

The shell interface 44 facilitates the translation of protocols from the protocols employed by the external application to the protocol employed by the management unit, when such protocols differ from one another. The shell interface 44 includes method that are used to facilitate communication with external systems. A Command Line Interface (CLI) method is available for accessing the management unit's functionality, by external systems that are capable of activating or scripting shell level commands. The CLI interface supports discovery, surveillance, and provisioning tasks on the managed network. The CLI interface is preferably facilitated by way of the Shell interface 44, which is written in the Java programming language and thus can run on any platform, such as Unix or Windows. In one embodiment, Extensive Markup Language (XML) is used to transfer configuration data to and from the management unit. ASCII file are based on an XML format-supporting scheme for input file validation. XML files are based on a Document Type Definition (DTD) scheme for file format validation. The Common Object Request Broker Architecture (CORBA) interface sends messages by way of the Object Request Broker (ORB) component to enable remote application event registration, including fault, and configuration changes. The CORBA API is based on 3^{rd} party software available for Java and C++ environments and is used for provisioning, surveillance, and auto-discovery.

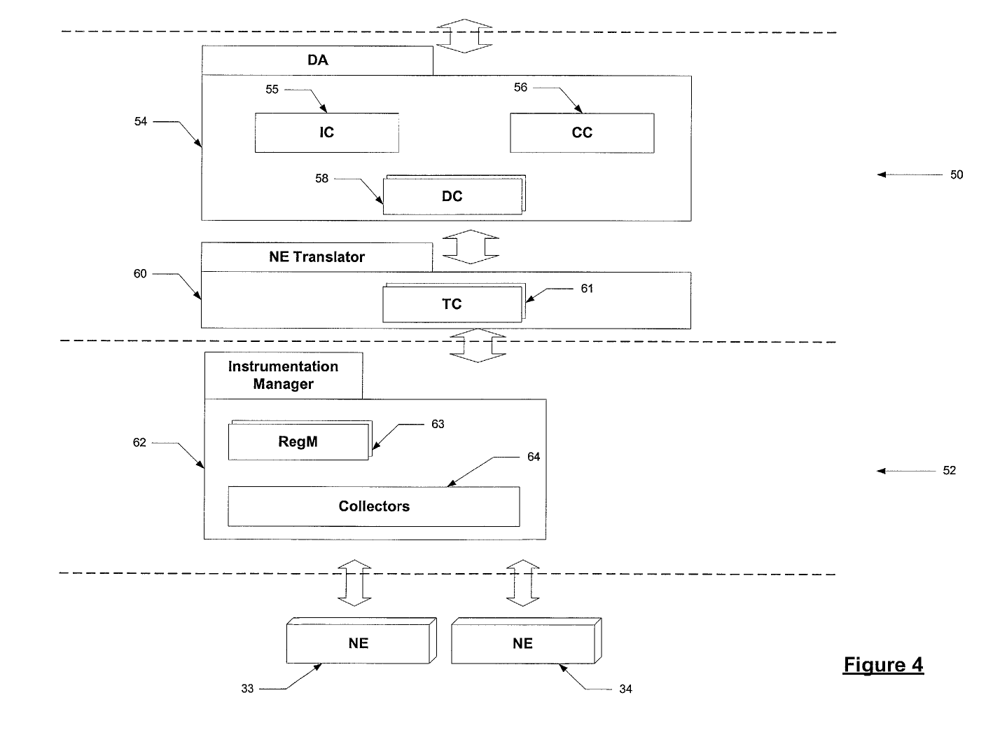

FIG. 4 illustrates some exemplary components of the warehouse tier 52 and the agents tier 50 of FIG. 3. The agents tier 50 preferably includes a plurality of agent modules 54 and a network element translator 60. In one embodiment, each agent module 54 includes an investigation component 55, a configuration component 56, and a plurality of device components 58. The network element translator 60 includes a plurality of translator components 61 that provide translation services to the agent modules.

The warehouse tier 52 includes an instrumentation manager 62 that facilities the communication with network elements. The instrumentation manager 62 includes a plurality of collectors 64 that collect data from the network elements by employing network communication protocols. The instrumentation manger 62 further includes a registry 63 that stores registration data, which is submitted by device components 58 of agent modules 54 so as to receive network element data.

In operation, the investigation component 55 configures device components 58 to model network element functionality. The network element data is preferably used by the investigation component 55 to select and then configure device components 58. The investigation component contains information on the location of the relevant network element configuration data and requests the information by employing a translation component 61 of the network element translator 60. The translation component 61 responds by translating the request to a specific data collection method. The investigation component 55 advantageously repeats the investigation process in order to provide an updated view of the network element. The re-investigation operation preferably takes place periodically, in accordance with a defined interval. In response to the investigation, device components 58 are instantiated and a corresponding translation component 61 is associated with each device component. After the instantiation, each device component 58 obtains information, which is employed to model the observed functionality by communicating with the warehouse 52 tier using an associated translation component 61.

The configuration component 56 is used to structure command sequences for submission to the device components so as to execute functions provided to the application tier 46. The configuration component 56 preferably stores information related to procedures available from each device component so as to facilitate the formatting of instructions to device components 58 and to facilitate requested functions. In one embodiment, the configuration component 56 maps received requests from external applications to stored device component instruction sequences. The configuration component then transmits the instructions to the corresponding device components. Configuration changes are facilitated by the configuration component 56 employing information stored in relevant device components to request device component operation that results in the activation of services of network elements. When an operation request is received by the configuration component 56, the component, prior to implementing the operation, verifies the activation. The configuration component 56 maps the request to a known set of operations on the device components that correspond to the affected network element functions. The configuration component 56 performs the operations as an atomic operation, which is successful only when all its subsequent operations are verified. In the case of a failure by any one of the operations in the request, the configuration component 56 performs a rollback procedure, which ensures network integrity.

In one embodiment, each agent module is associated with one network element. In another embodiment, each agent module is associated with a plurality of network elements whereby the agent module models the collective behavior of the associated network elements.

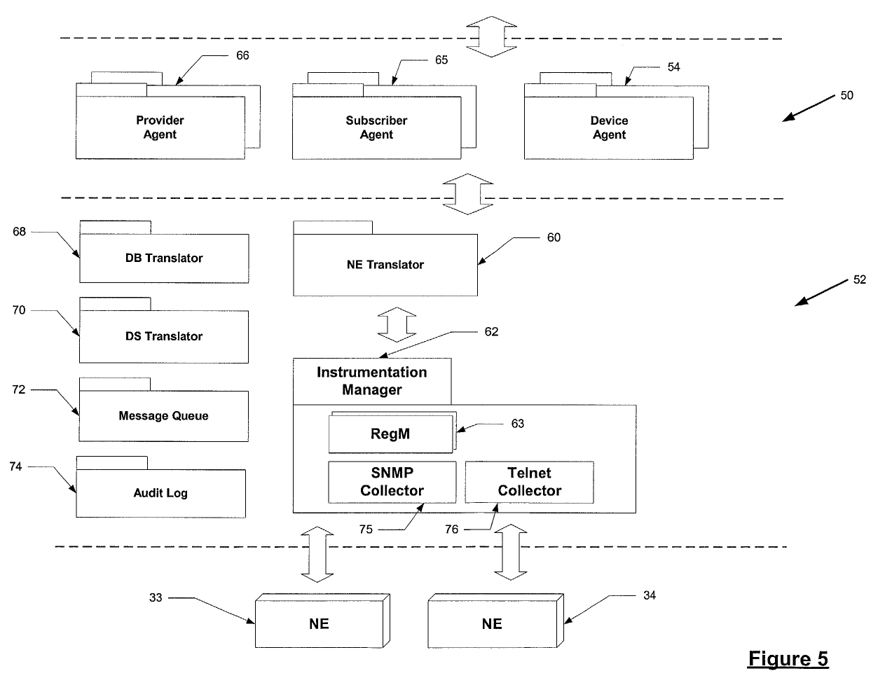

FIG. 5 illustrates the warehouse tier, related agent modules, as well as corresponding network elements. As discussed above, the warehouse tier 52 provides an interface between the network elements and the agent modules in the agents tier 50. In one embodiment, the warehouse tier 52 includes a network element translator 60, a database translator 68, a directory service translator 70, a message queue 72, an audit log 74, and an instrumentation manager 62. The instrumentation manager 62 includes a plurality of collector modules 75, 76, 77, 63, as discussed above, as well as a registry 63.

The network element translator 60 preferably maps agent functions to network element functions. The database translator 68 provides an interface for accessing database services. In one embodiment, the database translator 68 provides mediation and abstraction functions for the Relational Database Management System (RDBMS) engine and the management unit's components. The database translator 68 preferably receives requests for the storage and retrieval of management unit Information in the form of object data corresponding to a local portion of a model. The database translator 68 preferably translates the requests to Standard Query Language (SQL) transactions. When retrieving data, the database translator 68 converts the data to objects that can be handled by the other components. The database translator 68 preferably interacts with the components via the message queue 72. Accordingly, storage and data retrieval requests are sent to the database translator 68 via the message queue 72.

The directory service translator 70 provides network addresses for agent modules of the management system so as to allow for sending messages between agents over the message queue 72. In addition, the directory service translator 70 facilitates the updating and synchronizing of data across the management system. The directory server translator 70 serves as a distributed repository for naming resolutions across the system. The directory server translator 70 facilitates translation of addresses to local references which are stored within the repository. The directory server translator 70 facilitates name resolutions and reference storage for the components of the management unit. The directory server translator 70 interacts with third party Lightweight Directory Access Protocol (LDAP) servers, which handle data distribution and synchronization throughout the management system. The directory server translator 70 provides functions including: providing Global Identification (XID) to agent module IP address, providing an identifier to its properties, locating a subscriber identifier, locating a network element, and converting between an IP address and Global Identification (XID). In one embodiment, the directory service translator 70 further stores network element identifiers and corresponding local references.

The agent modules employ the message queue 72 to transmit messages. Accordingly, the agent modules are not aware of the location, within a management unit, of other agents. The message queue 72 is also used for transmitting registration requests to the registry. In one embodiment, the message queue 72 is implemented as a Java Messaging System (JMS). The message queue 72 serves as a general transport bus for messages that are passed between components. In one embodiment, the message queue 72 handles communication with remote components and provides message bus services throughout the distributed systems. The services provided by the message queue 72 include facilitating internal messaging within the management unit, facilitating external messaging between remote management units, enabling asynchronous interoperability between software components by queuing messages that are to be processed, and enabling messages to be broadcast to a plurality of targets. In addition, the message queue 72 interacts with third party systems, handling the transportation of data to and from the systems.

The audit log 74 is used to store historical data relating to management tasks and network conditions, such as errors, recovery procedures, reports, and history. The audit log 74 facilitates the logging of events and errors that are generated by the components.

The audit log 74 provides a general method for use throughout the system for reporting software events. An event, or software exception, that is generated by a component is tagged and logged by the audit log 74. The event data is stored in the local database by using the database translator 68. The events handled by the audit log 74 preferably have a defined structure that includes event severity, description, event-time, and event-originator. The events are stored in each management unit local database and can be accessed by way of an optional viewer application (not shown). The viewer is preferably a user interface application that facilitates logged software event viewing and filtering.

The instrumentation manager collector modules 75, 76 preferably facilitate the communication of the instrumentation manager with the associated network elements 33, 34. In one embodiment, the protocols supported by the collector modules include SNMP, Telnet, TCP/IP, TL1, FTP, and CORBA. An SNMP collector 75 facilitates SNMP protocol communication with network elements. The SNMP collector 75 translates collection requests and activation commands to SNMP syntax. In addition, the SNMP collector 75 sends and receives UDP packets. The SNMP collector 75 parses SNMP information and provides the information to the requesting components. The SNMP collector 75 is preferably instantiated by the instrumentation manager 62 and is associated with specific information requests.

The Telnet collector facilitates Telnet protocol communication with network elements. The Telnet collector manages a session with a network element, parses received information, and returns a response to the requesting network element translator. The Telnet collector 76 is designed to handle various proprietary Telnet based protocols.

The registration manager (“RegM” in the Figures) 63 facilitates registration requests to collect information from network elements. The device components register with the registration manager 63 for object information that is collected from network elements. The registration manager 63 is used by the network element translator 60 to retrieve information from network elements. Information requests are preferably handled by the registration manager 63 as registration requests. The registration manger 63 creates data collection requests in response to a registration request requests by communicating with corresponding collectors. The registration requests preferably include the required interval between data collections and an identification of target objects or functionality. In one embodiment, the registration manager 63 aggregates several requests into one collection action, thereby reducing the number of collection actions. The information received from the network element is distributed between the registered translator components 60 according to the data in the registry. In another embodiment, a registration request is performed in an immediate mode, i.e., with a wait interval of zero. This method forces the registration manager 63 to obtain the requested information without any delays, such as those attributed to request aggregations. Accordingly, registration results in device components receiving data relating to the functionality of a network element by periodically querying the network element.

The logical operation and arrangement of modeling components will now be discussed with reference to exemplary modeling of network elements. Each device component preferably models a particular functionality of the network element. In some embodiments, several device components are combined to one modeling entity that corresponds to a plurality of network element functions. Device components preferably model two main attributes of network element functioning: the operation of the function, and the external functions that are related to the modeled function. Accordingly, each device component is adapted to provide at least two services to the overall management scheme: determining how a given input affects the modeled functionality, and determining which other functionalities are affected by the given input or its consequences.

For example, a device component that is modeling a network switch's physical function stores identifiers for the device components modeling physical connections to the switch. The physical connections are defined as the peer relationships for the modeled functionality. Peer functions are external functions that are affected by the modeled function's operation. The device component also stores the logical or physical functionality that depends on each such modeled functionality. In the example of the physical switch function, a logical protocol function such as Asynchronous Transfer Mode (ATM) port function may depend on the physical function. Thus, the device component stores an identifier for the dependent device component, modeling the logical function. This dependency dictates the device component that the device component is related to in a parent-child relationship. Both peer and parent-child relationships are used during network management operations to provide for the intelligent collection of data and for the control of network elements.

The device components are each designed to model and monitor a targeted function of a network element. All device components for the same function are spawned, or initiated, with substantially the same configuration data. The corresponding investigation component then queries the target network element to acquire data relating to the modeled function. As the investigation component acquires information about the modeled function, the device component is configured accordingly, thereby producing a new model. Hence, the device component's operation is dynamically configured by obtaining awareness about attributes of the modeled function. As may be appreciated, the device component periodically receives updated data regarding the associated function to update its model of the function.

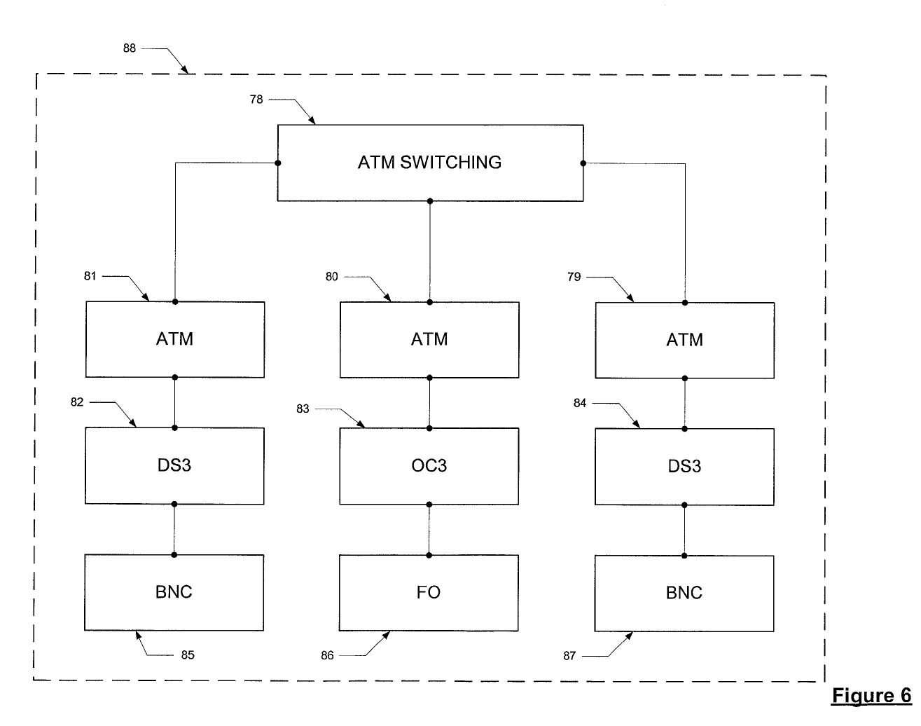

FIG. 6 illustrates an exemplary modeling of network element functions by device components. An ATM switch agent module 88 includes an ATM switching device component 78 that is associated with three ATM device components 79, 80, 81. A first ATM device component 79 includes a first T-3 line (DS3) device component 84 that employs a first Bayonet Connector (BNC) plug device component 87. A second ATM device component 80 includes an Optical Carrier 3 (OC3) device component 83 that employs a fiber optic plug device component 86. A third ATM device component 81 includes a second DS3 device component 82 that employ a second BNC device component 85. The links between the device components indicate dependencies between functionalities. The round link ends represent stored data. For example, the ATM switching device component 78 has a child relationship with the three ATM device components 79, 80, 81 because the ATM switching function depends on the ATM ports to facilitate ATM protocol connection. Accordingly, the ATM switching device component 78 stores three link indicators, one for each device component. Each of the three ATM device components 79, 80, 81 has a parent relationship with the ATM switching device component 78 because they provide services to the ATM routing function. In one embodiment, all device components modeling a particular network element are part of a single agent module.

As may be appreciated, network element function dependencies dictate the linking between device components. For example, the first ATM device component 79 has a child relationship with the first DS3 device component 84 because the investigation of the ATM switch provided configuration data indicating that the first ATM port has the first DS3 function as its connectivity path. Furthermore, the first DS3 device component 84 has a child relationship with the first BNC device component 87 because the investigation of the ATM switch provided that the DS3 connectivity is employing a BNC connector to pass data to the physical link. In another embodiment, the parent-child links are set in accordance with predefined agent structure for various network element types.

The relationships between the functions are preferably provided by the periodic querying of the network element. If the relationships change, the device components receive the change data from the associated translation components and make corresponding changes to the model. For example, in one configuration, when a module that contains the ATM, DS3, and BNC functions is removed from the network, such as when a card is removed from a device, the corresponding device component that are modeling the lost functionality are removed from the corresponding agent module. When functionality is added to the network, such as when a card is added to a device, an investigation procedure detects the new functionality and initiates device components corresponding to the gained functionality.

When a new kind of functionality is introduced to the system, perhaps as part of a new kind of network element, there is no need to redesign the management system. At such times, only a new device component that is configured to model the new function is added to the system. The communication interfaces between device components, as well as the overall operation of the agents' modules are not affected by the new type of network element. Accordingly, the system of the invention is adapted to be easily updated when technology changes and new functions are introduced to the network.

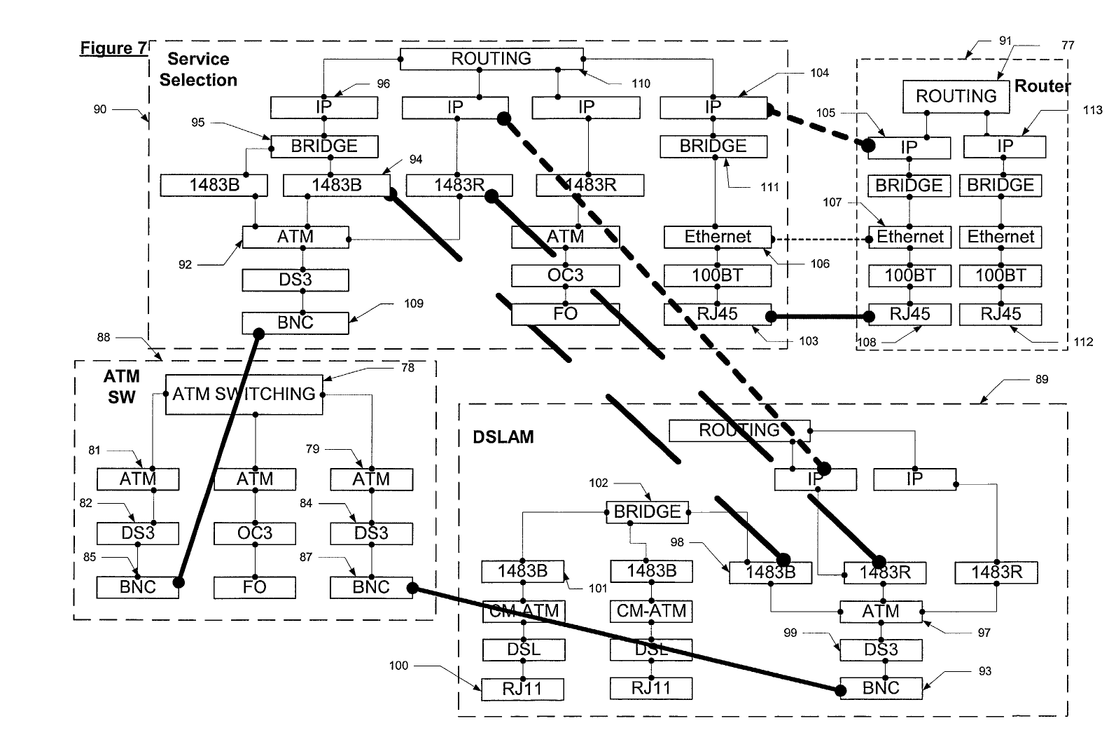

FIG. 7 illustrates the modeling of functions in several network elements of an exemplary network. Four agent modules are illustrated. A first agent module 89 models a DSLAM server. The agent model for the DSLAM server includes device components for DSL, ATM, 1483B protocol, RJ11 plug, 1483R protocol, Bridge, BNC, and IP functions. A second agent 88 module models an ATM switch, as was illustrated in FIG. 6. A third agent module 90 models a service selection switch. The service selection switch agent model includes device components for BNC, ATM, 1483B protocol, 1483R protocol, Bridge, Ethernet, and IP functions. A fourth agent module 91 models an ISP router. The router agent model includes device components for RJ45, 100BT, Ethernet, Bridge, and IP functions. As may be appreciated, the modeled network elements can include various other functions, which are modeled by corresponding device components. However, for illustration purposes, FIG. 7 includes limited device components, which are discussed in connection with the example flow illustrated below.

Within each of the agent models, device components are associated by parent-child links. For example, in the service selection switch agent 90, a first ATM device component 92 is the child in a parent-child link with two 1483B device components 93, 94 and a 1483R device component 95. Conversely, each of the protocol device components 93, 94, 95 is the parent in the parent-child link with the ATM device component 92. Thus, the first ATM device component 92 has stored four relationship indicators for parent-child links, three as a child and one as a parent to the DS3 device component 109.

The illustrated model further includes peer links between device components in different agent modules. For example, a first BNC device component 87 in the ATM switch agent 88 has a peer link with a BNC device component 93 in the DSLAM agent module 89. A third BNC device component 85 of the ATM switch agent module 88 has a peer link with a BNC device component 109 of the service selection agent module 90. As may be appreciated, other peer links are included for device components of the illustrated agent modules. However, for illustration purposes, a limited set of the peer links is shown.

The network model, provided by the device components and corresponding links, is used to facilitate various network management tasks. The network model allows for navigating between device components over various abstraction levels, i.e., device component hierarchal levels, depending on the desired task. In some instances, the network model is traversed by following the device component links from a starting point device component to a target device component to determine, for example, the device components associated with the data path between the starting point and the target. Accordingly, the network model is traversed by moving down to the lowest level device components, which model the network functionality, carrying the electrical signals. In other instances, the network model is used to propagate a fault indication, originating from a source device component, so as to asses the scope of affected network elements. Accordingly, for the fault task, the network model is only traversed until no fault is detected by the device component. Furthermore, when the fault is determined to be related to a logical function, the propagation does not move downward to the lowest level device components. Two example traversing flows are discussed below, illustrating tracing the model for a path determination task, and for a fault propagation task, respectively.

In a first example, the peer links between device components are employed by the management system to trace the device components associated with a path between a starting network point and a target network point. In the example, the starting network point is the RJ11 plug of the DSLAM. The target network point is the RJ45 plug of the ISP router. In one embodiment, the device components are traced as part of a path verification task, which is requested by an external application communicating with a management unit. The operation of the management units when facilitating the implementation of task requests is discussed below with reference to FIGS. 10, 11, and 12. The present discussion focuses on the device component mapping arrangement that is used in facilitating such tasks.

The path between the RJ11 plug and the RJ45 plug is traced by following the path that data travel when transmitted between the plugs. As discussed above, each device component is adapted to model how a network element function reacts to data input. Each device component is aware of the directing decision made by the associated network element function in response to receiving data. Thus, the device components, and in turn the network element functions, which are associated with the data path, are identified by employing these decisions. In the data path example, a data structure is preferably transmitted between device components whereby an identifier for each device component in the path is appended to the structure by the corresponding device component.

The RJ11 device component 100 directs data, by way of a DSL device component, a CM-ATM device component, and a first 1483B device component 101, to a bridge device component 102. The bridge device component 102 directs data from the first 1483B device component 101 to a second 1483B device component 98. The second 1483B device component 98 directs data to an ATM device component 97. The ATM device component 97 directs data, by way of a DS3 device component 99, to a BNC device component 93. The BNC device component 93 has a peer link with a first BNC device component 87 of the ATM switch agent module 88. Accordingly, the BNC device component 93 directs data from the DS3 device component 99 to the first BNC device component 87.

The first BNC device component 87 directs data from the BNC device component 93 to a DS3 device component 84. The DS3 device component 84 directs data to a first ATM device component 79. The first ATM device component 79 directs data to an ATM switching device component 78. The ATM switching device component 78 directs data to a third ATM device component 81. The third ATM device component 81 directs data, by way of a DS3 device component 82, to a third BNC device component 85. The third BNC device component 85 has a peer link with a first BNC device component 109 of the service selection switch agent module 90. Accordingly, The third BNC device component 85 directs data to the first BNC device component 109.

The first BNC device component directs data, by way of a DS3 device component, to a first ATM device component 92. The first ATM device component 92 directs data to a 1483B device component 94. The 1483B device component 94 directs data to a bridge device component 95. The bridge device component 95 directs data to a first IP device component 96. The first IP device component 96 directs data to a routing device component 110. The routing device component 110 directs data to a second IP device component 104. The second IP device component 104 directs data to a bridge device component 111. The bridge device component 111 directs data to an Ethernet device component 106. The Ethernet device component 106 directs data, by way of a 100BT device component, to an RJ45 device component 103. The RJ45 device component 103 has a peer link with a first RJ45 device component 108 of the router agent module 91. Accordingly, the RJ45 device component 103 directs data to the first RJ45 device component 108.

The first RJ45 device component 108 directs data, by way of a first 100BT device component, a first Ethernet device component 107, and a first bridge device component, to a first IP device component 105. The first IP device component 105 directs data to a routing device component 77. The routing device component 77 directs data to a second IP device component 113. The second IP device component 113 directs data, by way of a second bridge device component, a second Ethernet device component, and a second 100BT device component, to a second RJ45 device component 112. Therefore, a path is traced from the RJ11 device component of the DSLAM 89 to the second RJ45 device component 112 of the router 91. The resultant data structure, which includes the device component identifiers, is preferably transmitted back to the requesting management unit where the path determination task originated.

A second example is of a fault propagation at the protocol level. A fault is detected by the Ethernet device component 106 of the service selection switch 90. The fault is identified as an address conflict with another Ethernet protocol. The fault thus does not apply to the physical functions below the Ethernet protocol. Accordingly, the fault data is only delivered upwards, i.e., to parent and peer device components. The Ethernet device component 106 transmits a message indicating the fault condition to its peer Ethernet device component 107 and to its parent bridge device component 111. The Ethernet device component 107 of the router agent module 91 responds by determining if the fault condition is affecting the operation of the observed function. If the operation is affected, a message is directed to parent and peer device components. The same procedure is followed by all device components receiving the fault message. When the fault condition does not affect the device component, the message is preferably not transmitted. Hence, the extent of a fault condition can be determined by employing the network model provided by the device components and associated links.

As may be appreciated from the discussion above, the model that is provided by the agent modules can be traversed over several paths and at different levels. Thus, if a certain task is applicable to protocol level device components, the model is preferably traversed at the protocol level. On the other hand, when a task is applicable to lower level device components, the model is traversed over the lower levels.

In one embodiment, additional device agents types are included in the management units. The additional agent types facilitate the modeling of specialized logical entities in the network. Examples of such device agents include a subscriber agent and a provider agent. One example is when a subscriber agent models a DSL service subscriber and communicates with a device agent that models DSLAM equipment. The device agent for the DSLAM shares information regarding the status of ports, which connect subscribers to the DSLAM device. In the case of a port failure, the subscriber agent is notified by its acquaintance with the device agent modeling the DSLAM.

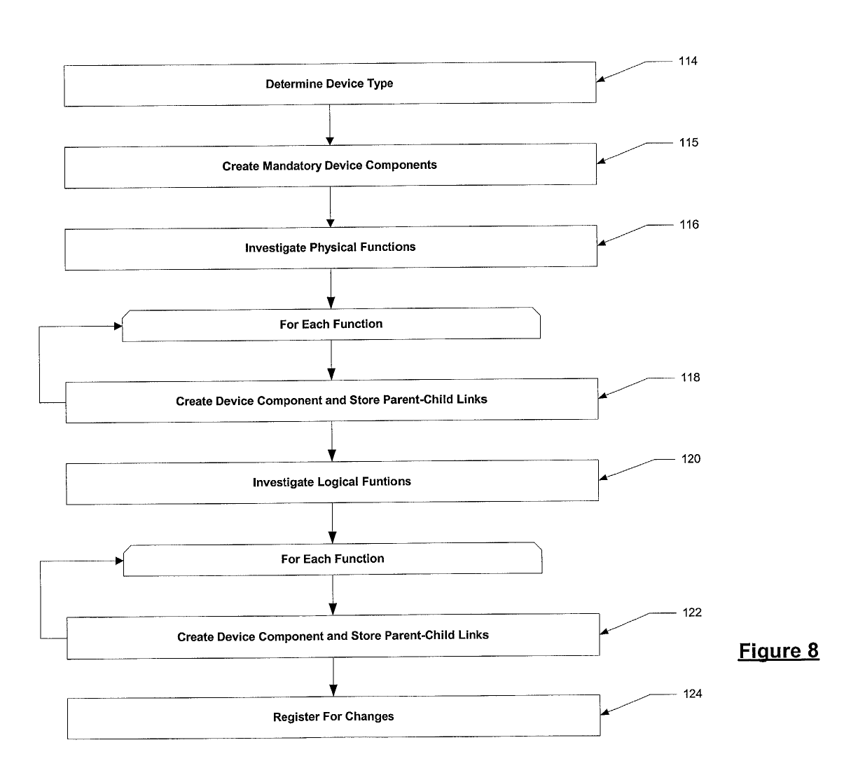

FIG. 8 is a flow diagram illustrating the operation of the investigation component when configuring the acquaintance relationships for a device component. The investigation component 55 retrieves device data to allow for the setup of corresponding device components 58. The investigation is preferably of the physical layout and logical layout of the network elements. The investigation component 55 generates an instance of a device components 58 for each observed functionality.

The investigation component 55 starts by identifying the device type for the observed network element (Step 114). The investigation component initiates a base set of device components in accordance with the observed device type (Step 115). The physical functions associated with the network element are identified (Step 116). For each identified function, the investigation component 55 initiates a corresponding device component (Step 118). The investigation component 55 further configures the parent-child links for the device component in accordance with the identified device type (Step 118). The investigation component 55 proceeds to identify logical functions associated with the network element (Step 120). For each logical function, the investigation component 55 initiates a corresponding device component (Step 122). The investigation component further configures the parent-child links for each logical function device component. Finally, the investigation component registers each of the configured device components with the registry 63 of the warehouse tier 52 so as to receive data corresponding to the observed function.

The interaction between device components 58 is advantageously predefined in accordance with the functionality that each device component is modeling. Device components preferably communicate data by traversing the relationship model from end to end, as discussed above. In one embodiment, each device component reacts to received messages in accordance with its parent, child, and peer relationships. In this embodiment, when a device component receives a message from a child device component there is an action that takes place. The action, or routing decision, includes forwarding the message to a child, a peer, a parent, or all three. For example, when a communication link is broken, the device component transmits a message to parent and peer device components so as to verify that the link is indeed broken. The message then propagates to other device component by a similar decision process, taking place in the receiving parent and peer device components. Accordingly, the message, indicating a broken link, propagates through the management system in accordance with the distributed logic that is contained in the device components. On the other hand, for a bad circuit within the network element, the device component response may entail a report to an external management process without transmitting a message to other device components.

In operation, the device components collect data from the network element and make independent decisions regarding the data. The device components communicate with one another according to predefined logic to facilitate the execution of tasks for external systems. The management network provides a minimal set of data to the external processes, and require less direction in executing tasks, thereby reducing the required processing power of external management systems.

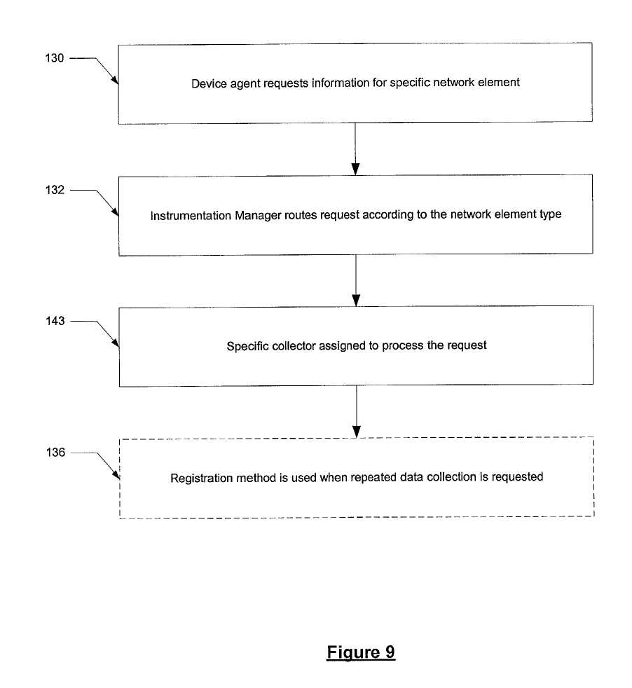

FIG. 9 is a flow diagram illustrating the operation of a management unit when device agents collect data from network elements. A device agent 54 requests information corresponding to a network element (Step 130). The instrumentation manager 62 routes the request to an appropriate collector 64 in accordance with the network element type of the subject network element (Step 132). A specific collector is thereby assigned to collect the requested information (Step 143). When repeated data collection is needed, the device agent 54 employs the instrumentation manager 62 to register for the information and receive periodic updates (Step 136).

Different types of device components advantageously include different routing algorithms for responding to unique conditions that can arise in the observed function. Accordingly, device component behavior is preset in accordance with the modeled functionality. However, the targets for the routing operation are advantageously dynamically identified according to the configuration and operation mode of the observed functionality.

The present invention facilitates the implementation of network provisioning requests in a single step communication instead of the step-by-step supervision required to facilitate such operations in prior systems. An application server (APS) in the application tier exports services to client applications, which are coupled to the management unit. The APS handles client application sessions and requests. In addition, the APS communicates with the warehouse tier components and agents tier components by using the message queue.

FIG. 10 illustrates the logical components of the APS and management unit that are associated with the provision of services to external applications. Generally, APS modules in remote management units interact with one another by passing messages over the message queue. In one embodiment, the interaction facilitates information requests and registration for data from remote management units. The APS structures the interaction sequence with remote APS in accordance with the received request. The structuring includes identifying the address of the remote management unit by accessing the directory service translator 70 and composing a message directed to the message queue 72 in accordance with the desired operation. In another embodiment, the APS is used for immediate response tasks, or snapshot requests. A snapshot request provides that a single APS can view the entire managed network (inventory or topology).

The APS 140 includes a session manager module 142, an authentication manager module 144, and a plurality of service routines 146. The session manager module 142 is used to manage sessions with client applications that are operatively coupled to the application server. The authentication manager module 144 is used to authenticate client applications prior to processing requests from the applications. In one embodiment, each one of the available service routines is implemented a software module that includes commands that facilitate the execution of tasks requested by external applications.

The management unit modules that communicate with the application server include agent modules 150, 152, 154, 156 in the agents tier and local task routine (Xtask) 148. The Xtasks 148 facilitate the local implementation of requested services by communicating with corresponding agent modules. Preferably, for each service routine that is requested by an external application, an Xtask is spawned in each management unit associated with the service.

In operation, an Xtask 148 is first spawned in the management unit that is coupled to the external server. The Xtask 148 executes an algorithm that allows it to identify another management unit that is associated with the requested service. In one embodiment such identifying includes referring to the prior links associated with device components in agent module. The Xtask transmits a message to other management units to prompt local Xtasks at the management units. The Xtask also transmits a corresponding message to local agent modules. The agent modules cooperating in the local implementation of the Xtask routine include device agent modules 150, subscriber agent modules 152, provider agent modules 154, and network provider agent modules 156.

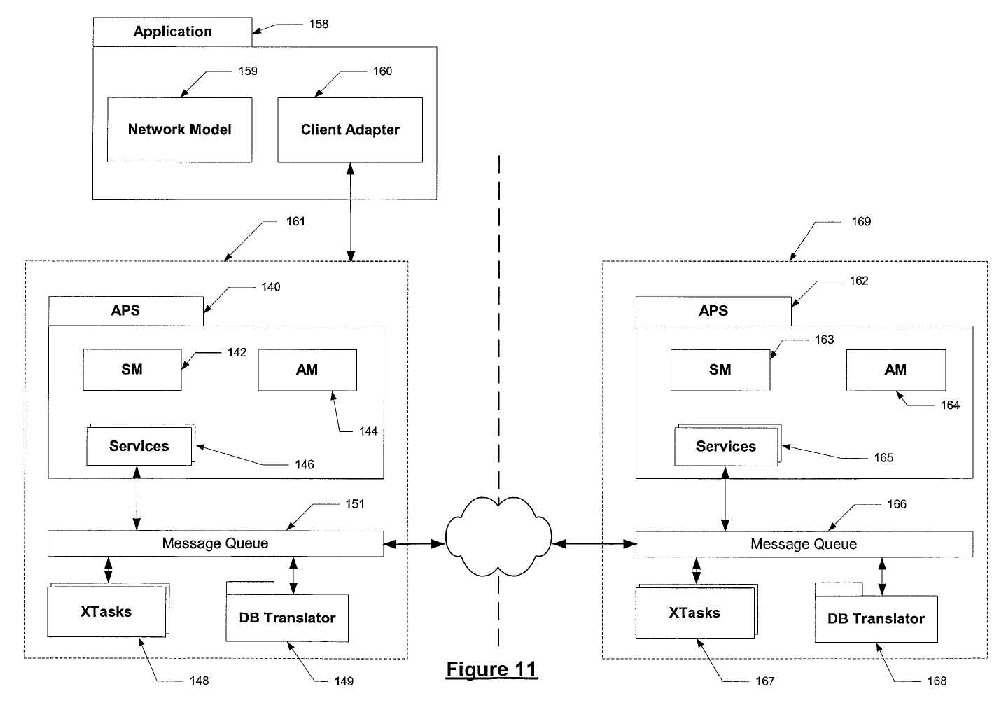

FIG. 11 illustrates the logical modules associated with the execution of external services by at least two management units. The external application 158 includes a local network model 159 and a client adapter 160. A client adapter is available to external applications for communicating with management units and for sending task requests to local APSs. In one embodiment, the client adapter 160 facilitates communication between the application tier 46 and the presentation tier 48 by providing services that include protocol management, authentication, and data transfer. The external application 158 is operatively coupled to a management unit 161 by a management network communication link. The client 160 adapter communicates with an APS 140 in the management unit 161. The APS 140 includes a session manager 142, an authentication manager 144, and a plurality of service routines 146, as discussed above. The service routines 146 execute and prompt the communication with the message queue 151 of the management unit 161. The message queue transmits a message to spawn local Xtasks by employing the directory service translator 149 to resolve addresses of external management units. The message queue 151 is thus operatively coupled to message queues 166 in other management units 169. The second management unit 169 of FIG. 11 preferably includes the same operative modules as the first management unit 161.

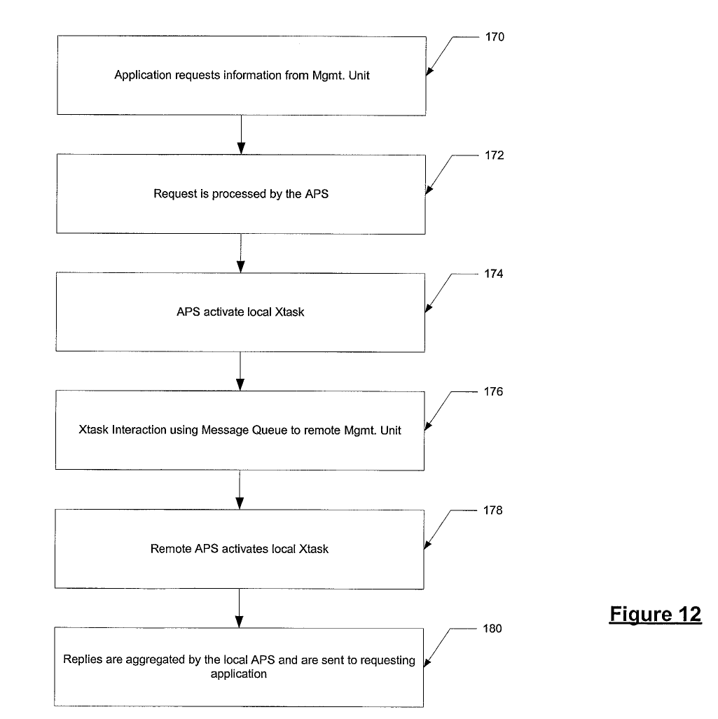

FIG. 12 is a flow diagram illustrating the operation of the management units 161, 169 when implementing an information request task for an external application. A first management unit 161 receives an information request task from the external application 158 by receiving a message to its message queue 151 from the client adapter 160 of the external application (Step 170). The request is forwarded from the message queue to the APS 140 (Step 172). After prompting a new session and authenticating the external application, an information request service routine 146 is prompted by the application server 140.

The APS 140 initiates an Xtask 148 for the requested operation (Step 174). The Xtask dispatches requests to the different device agents that are associated with the information request by employing addresses, as provided by the directory service translator 68. The requests are sent to the remote management unit 169 as messages in the message queue 151. The remote message queue notifies the remote APS 162 of the pending message. The remote APS 162 responds by initiating local Xtasks 167 (Step 178). The local Xtasks 167 request the desired information from associated device agents. The response from the remote application server 162 is sent back to the serving management unit 161 as a message in the message queue 151. The serving management unit 161 aggregates the replies from all the device agents into a single reply that is provided to the external application 158 (Step 180).

The agent modules are further adapted to communicate with each associated network element to facilitate operations. Such functionality includes facilitating state provisioning whereby the network ensures a state of service for a particular user of the network.

The management platform supports multiple, concurrent clients, for the various interface methods. Each external application can be provided with a custom view of the network.

Although the present invention was discussed in terms of certain preferred embodiments, the invention is not limited to such embodiments. Rather, the invention includes other embodiments including those apparent to a person of ordinary skill in the art. Thus, the scope of the invention should not be limited by the preceding description but should be ascertained by reference to the claims that follow.

What is claimed is:

1. A network management unit for managing a network that includes a plurality of network elements coupled by communication links, the management unit comprising:
a warehouse module, the warehouse module operatively coupled to at least one network element, the warehouse module adapted to interact with the network element to facilitate data retrieval and network element operation control;
an agents module, the agents module modeling functional operation of at least one network element that is in communication with the management unit, the agents module operatively coupled to the warehouse module to facilitate communication with the associated network element, the agents module adapted to transmit commands to the warehouse module to facilitate service requests; and
a presentation module, the presentation module facilitating local implementation of task requests from external management applications, the presentation module communicating with the agents module to transmit service requests to the agents module in accordance with the task requests.

2. The management unit of claim 1, further comprising an application module, the application module adapted to facilitate the transmission of task requests from external management applications to the management unit.

3. The management unit of claim 2, wherein the application module comprises:
a session manager to initiate and control a session with the presentation module;
an authentication manager to facilitate security clearance with the presentation module; and
a plurality of available service routines corresponding to services available from the presentation module.

4. The management unit of claim 2, further comprising a shell interface for facilitating communication between the application module and external management applications.

5. The management unit of claim 1, wherein the agents module comprises:
an investigation component, the investigation component adapted to initiate and configure device components for the agents module;
a plurality of device components, each device component modeling at least one network element function;
a configuration component, the configuration component adapted to facilitate the command execution by device component operations in response to receiving commands from the presentation module; and
a network element translator, the network element translator facilitating the communication between device components and the warehouse module so as to facilitate data translation between the device components and the warehouse module.

6. The management unit of claim 1, wherein the warehouse module comprises a registry and a plurality of collector modules.

7. The management unit of claim 1, wherein the warehouse module comprises:
a database translator to facilitate the storage and retrieval of network data and management unit configuration data;
a directory service translator to facilitate the resolution of addresses for network elements and external systems;
a message queue to facilitate the transmission of messages between management unit modules residing in remote management units;
a registry to facilitate the registration of the agents module for network element data; and
a plurality of collectors to communicate with network elements.

8. The management unit of claim 7, wherein the plurality of collectors comprises an SNMP collector.

9. The management unit of claim 7, wherein the plurality of collectors comprises a Telnet collector.

10. A method for processing network event data in a network including network elements coupled together by communication links, the network elements including logical and physical functions, comprising:
modeling the internal state behavior of the logical and physical functions of network elements by associating a modeling component with each function of a network element;
identifying dependencies and peer links for said logical and physical functions of the network elements;
associating each modeling component with corresponding acquaintance links in accordance with the identified dependencies and peer links for the associated function of the modeling component; and
transmitting at least one message from a first modeling component to a second modeling component in accordance with the acquaintance links of the first modeling component in response to network event data to facilitate the distributed processing of the network event data.

11. The method of claim 10, further comprising generating the message by referring to the network event data as applicable to a predetermined decision flow corresponding to the modeled function of the modeling component.

12. A method for implementing a network operation modification in a communication network including network elements coupled together by communication links, comprising:
associating each network element with at least one component that models the operation of functions in the network element, the component adapted to transmit operating commands to the network element;
receiving a command indicating a requested change in operation of the communication network;
verifying proper communication network operation by facilitating the command in the network modeling components; and
implementing the command by employing the network modeling components corresponding to each network element associated with the command if proper operation is verified.

13. A method for executing a network task in a communication network that includes a plurality of network elements operatively coupled by communication links and a management unit associated with each network element, comprising:
receiving task request data into a first management unit;
determining whether a portion of the task is applicable to the first management unit;
prompting the execution of a portion of the requested task in the first management unit when a portion of the task is applicable to the first management unit;
determining whether all portions of the task have been prompted for; and
transmitting a message to at least a second management unit when all portions of the task have not been prompted for, the message including the task request data.

14. A method for facilitating an information request in a management network that includes a plurality of management units, comprising:
receiving an information request from an external application into a first management unit;
processing the information request in an application server, the processing facilitating at least the identification of management unit services associated with the information request;
initiating a local task in the first management unit to facilitate a first management unit service corresponding to the information request;
transmitting a message from the local task to a remote application server in a second management unit, the message including at least the information request;
initiating a local task in the second management unit to facilitate a second management unit service corresponding to the information request;
responding to the message by transmitting a message from the application server in the second management unit to the application server in the first management unit, the response including result data for the local task;
aggregating responses from remote management units in the first management unit application server; and
transmitting a reply to the information request to the external application.

15. A method for modeling the functionality of a network element in a network, comprising:
communicating with the network element to identify functionality in network element;
spawning a modeling element corresponding to at least one identified functionality in the network element;
communicating with the network element to identify attribute data for the identified functionality; and
updating the modeling data employed by the modeling element in accordance with the attribute data for the identified functionality.

16. The method of claim 15, further comprising periodically communicating with the network element to identify changes to attributes of the network element and update the modeling data in the modeling element.

17. A method for managing network event data, comprising:
modeling parts of a network by associating individual modeling components with network functions, the modeling is of at least the relationships between the network functions;
receiving network event data into a modeling component;
selecting an event response operation in the modeling component by referring to the network event data;
transmitting at least one message to a second modeling component, the message including data in accordance with the event response operation result, the transmitting is in accordance with relationships corresponding to network functions associated with the modeling component.

18. A method for facilitating the execution of a task, which requires end-to-end knowledge of a network, comprising:
modeling parts of the network by individual modeling components, the modeling is of at least the relationships between physical and logical functionalities and the operation of functionalities of network elements;
transmitting commands from the modeling components to an associated network element to control the operation of the functionality; and
transmitting a plurality of messages between said modeling components to facilitate a portion of the task in each component, whereby each component communicates with associated functionality if the functionality is part of the required task, the message directed in accordance with the relationships provided by the modeling components.

19. The method of claim 18, wherein the task is an information query.

20. The method of claim 18, wherein the task is a provisioning operation.

21. A method for identifying target management components for network task operations, comprising:
associating an autonomous agent with at least one network element in the network;
associating a plurality of device components with each autonomous agent, each device component modeling a data network entity;
storing dependency links between device components of an autonomous agent in accordance with dependencies associated with the modeled data network entity corresponding to the autonomous agent;
storing peer links between device components of a first autonomous agents and a second autonomous agent in accordance with logical and physical links between a data network entity corresponding to the first autonomous agent and a data network entity corresponding to the second autonomous agent; and
referring to the stored dependency links and peer links to identify target device components for network management task implementation.

22. A method for passing information between autonomous agents modeling logical and physical functions, comprising:
storing relationship identifiers for each modeling agent, the relationship identifiers corresponding to physical and logical connections between the functionalities; and
transmitting a message from an autonomous agent in response to an event by employing at least the stored relationship identifiers associated with the agent.

23. An extensible software architecture for facilitating the mapping and analysis of a communication network, comprising, on a computer readable medium:
a mapping component which has executable code for scanning a network and for generating a map of the network, the map represented by the mapping component as a data structure which comprises a collection of device components and links, the device components representing functions of network elements of the network and the links representing relationships between the device components; and
an application program interface which includes methods that enable external applications to access the device components of the map data structure to obtain information about the network, and which includes methods that enable the external applications to modify the operation of the network and to convey network information to a user via a user interface.

24. A method for modeling a network element for facilitating the mapping and analysis of a communication network, comprising:
associating functions of the network element with device components, whereby each device component models the operation of an associated function;
storing link data for relationships between functions of the network element; and
associating link data to a device components by referring to the function which is associated with the device components.

25. A method for retrieving function data corresponding to a function of a network element, comprising:
transmitting a request from a modeling component to an instrumentation manager, the request identifying a network element function;
receiving the request by the instrumentation manager and forwarding the request to a collector element in accordance with the network element type;
collecting data from the network element by the collector element receiving the request;
transmitting network element data to the instrumentation manager;
formatting the network element data for use by the requesting modeling component; and
transmitting the formatted data to the modeling component to provide network element function data to the modeling component.
